(19) United States
(12) Patent Application Publication
(10) Pub. No.: US 2011/0283177 A1
(43) Pub. Date: Nov. 17, 2011

(54) On-line document approval management system

(76) Inventors: Troy Gates, Sun Prairie, WI (US); Troy David Weaver, Leighton, PA (US)

(21) Appl. No.: 12/080,619

(22) Filed: Apr. 4, 2008

Related U.S. Application Data
(60) Provisional application No. 60/921,948, filed on Apr. 5, 2007.

(51) Int. Cl. G06F 17/24

(52) U.S. Cl. 715/224

(57) ABSTRACT

The present invention is directed to a method for approval of a document and an on-line document approval management system. This invention is particularly directed to a method for approval of contract documents and an on-line system thereof.

### FIELD OF INVENTION

The present invention is directed to a method for approval of a document and an on-line document approval management system using said method. This invention is particularly directed to a method for approval of contract documents and an on-line system thereof.

### BACKGROUND OF INVENTION

Many companies struggle with document management today. It is expensive and tedious to keep data up to date, to track changes and modifications to the document such as a legal contract, and to obtain approvals at required levels. Many companies are using paper documents and sending paper mails or faxes to exchange and manage the documents. Electronic processes, such as e-mail process, are being used by many companies. In a typical e-mail process, a user edits or otherwise modifies a document and sends the document in an electronic form to an approver. The approver subsequently approves or denies the editing or modifications and sends the approval or denial decision back to the user. This process, however, generated multiple copies of the document with various modifications in each copy and causes difficulties in tracking changes, monitoring approval status, and ensuring accuracy of the document. It is often desired that the document is in a secured form that means the document cannot be altered by unauthorized person or persons. In typical electronic processes, a user's editing authorization is applied to the entire document. Edit control is not available for individual parts of the document such as a particular term or field in a contract.

It is generally known that certain electronic documents can have some level of security features. For example, a Microsoft® Word document can have a password protection so any modifications made to the Word document cannot be saved into the same document if an appropriate password is not provided. Those security features, however, can only protect the entire document from unauthorized modification. Once a user has the authorization, such as being given appropriate password, the user can edit or modify any parts or fields of the document.

For some documents, such as a contract, some fields or terms can be readily modified by an authorized user, while some other fields or terms, such as compensation or payment amounts can be edited by the authorized user, but require additional approval from one or more approvers. For a contract between two or more parties, modifications and subsequent approval of such modifications becomes very difficult to manage.

It is therefore in need for a method for approval of a document that can track data modifications and subsequent approval of such modifications.

### STATEMENT OF INVENTION

This invention is directed to a method for approval of a document, said method comprising the steps of:
a) populating one or more fields of the document with data entered by an authorized user, wherein each of said one or more fields is associated with an authorization hierarchy;
b) sending an approval request for said one or more fields populated with the data to a initial approver in accordance with the authorization hierarchy;
c) generating a response notification according to input from the initial approver, wherein in the response notification at least one of said one or more fields populated with said data is assigned an individual approval or an individual denial;
d) sending the response notification to the user; and
e) repeating the steps a) through d) to populate at least one of the one or more fields that is assigned the individual denial in the response notification with new data until said field is approved by the initial approver.

This invention is also directed to a system for approval of a document, said system comprising:
a) a computing device comprising an input device;
b) a database accessible to the computing device, said database comprises information of an authorization hierarchy;
c) a computer program product accessible to the computing device, said computer program product performs a computing process comprising the steps of:
   i) populating one or more fields of the document with data entered by an authorized user, wherein each of said one or more fields is associated with an authorization hierarchy;
   ii) sending an approval request for said one or more fields populated with the data to a initial approver in accordance with the authorization hierarchy;
   iii) generating a response notification according to input from the initial approver, wherein in the response notification at least one of said one or more fields populated with said data is assigned an individual approval or an individual denial;
   iv) sending the response notification to the user; and
   v) repeating the steps i) through iv) to populate at least one of the one or more fields that is assigned the individual denial in the response notification with new data until said field is approved by the initial approver.

This invention is further directed to a method for approval of a document, said method comprising the steps of:
a) entering data by an authorized user to populate one or more fields of the document, wherein each of said one or more fields is associated with an authorization hierarchy;
b) submitting said data by said user for sending an approval request for said one or more fields populated with the data to a initial approver in accordance with the authorization hierarchy;
c) receiving by said user a response notification generated according to input from the initial approver, wherein in the response notification at least one of said one or more fields
c) a computer program product accessible to the computing device, said computer program product performs a computing process comprising the steps of:
   i) populating one or more fields of the document with data entered by an authorized user, wherein each of said one or more fields is associated with an authorization hierarchy;
   ii) sending an approval request for said one or more fields populated with the data to a initial approver in accordance with the authorization hierarchy;
   iii) generating a response notification according to input from the initial approver, wherein in the response notification at least one of said one or more fields populated with said data is assigned an individual approval or an individual denial;
   iv) sending the response notification to the user; and
   v) repeating the steps i) through iv) to populate at least one of the one or more fields that is assigned the individual denial in the response notification with new data until said field is approved by the initial approver.

This invention is further directed to a method for approval of a document, said method comprising the steps of:
a) entering data by an authorized user to populate one or more fields of the document, wherein each of said one or more fields is associated with an authorization hierarchy;
b) submitting said data by said user for sending an approval request for said one or more fields populated with the data to a initial approver in accordance with the authorization hierarchy;
c) receiving by said user a response notification generated according to input from the initial approver, wherein in the response notification at least one of said one or more fields populated with said data is assigned an individual approval or an individual denial;
d) repeating the steps a) through c) to enter new data by said user into at least one of the one or more fields that is assigned the individual denial in the response notification until said field is approved by the initial approver.

This invention is even further directed to a method for approval of a document, said method comprising the steps of:
a) receiving by an approver in an authorization hierarchy an approval request for approval of one or more fields of the document populated with data entered by an authorized user, wherein each of said one or more fields is associated with the authorization hierarchy;
b) inputting response by the approver to send a response notification to said user to approve or deny said one or more fields;
c) repeating the steps a) through b) to receive new approval request for new data entered by said user into at least one of the one or more fields that is denied in the response notification until said field is approved by the approver.

### BRIEF DESCRIPTION OF DRAWING

FIG. 1 shows a representative flow chart of one embodiment of the method of this invention.

FIG. 2 shows representative examples of (A) security levels; and (B) an authorization hierarchy.

FIG. 3 shows representative examples of (A) a login interface, and (B) a data entry interface.

FIG. 4 shows representative examples of (A) a file upload interface; and (B) an interface for reviewing existing file and electronic signature.

FIG. 5 shows representative examples of (A) locked fields, (B) unlocked fields, and (C) an interface for entering data into one or more fields.

FIG. 6 shows a representative interface for approval.

FIG. 7 shows representative examples of interfaces for approval and response. (A) An interface with “Approved” radius checked. (B) An interface with “Not Approved” radius checked and comments entered. (C) An example of response notification.

FIG. 8 shows a representative example of approval notification.

FIG. 9 shows representative examples of (A) an interface for inputting subsequent approval or denial, (B) a subsequent response notification, (C) an approval interface having previous approval history, and (D) a final approval notification.

FIG. 10 shows a representative hardware configuration of a system of this invention.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “document” refers to a collection of information. A document can be in printed or in digital forms. Examples of typical documents include, but not limited to, letters; e-mails; memorandum; certificates; a resolution from a board of directors, person or a group of persons, or other decision making body or social groups; web pages; contracts or agreements, such as a contract between two parties or companies; operation or product manuals; instructions, such as an instruction for mixing chemicals; tutorial materials, such a text book for teaching; product descriptions or data sheets, such as material safety data sheets (MSDS); a regulatory document that provides one or more lists of regulations, such as policies of a company or organization, bylaws of an organization, or Underwriters Laboratories (UL) listing; or any other collection of information in printed or digital forms. A digital document that can be accessed by a computer is preferred. A digital document that can be accessed by a computer through a wired or wireless network is further preferred. The digital document can be a stand-alone digital document stored in a computer; a computer readable storage device such as hard drive, compact disk (CD), or removable storage media such as a USB flash memory card; or in a database. The document can also be part of another document or a plurality of documents. A printed document, such as a printed paper document, can be converted into digital document, therefore can be used in this invention. One example for converting printed document into digital document includes, but not limited to, optical scanning.

A computing device used herein refers to a desktop computer, a laptop computer, a pocket PC, a personal digital assistant (PDA), a handheld electronic processing device, a smart phone that combines the functionality of a PDA and a mobile phone, or any other electronic devices that can process information automatically. A computing device may have a wired or wireless connection to a database or to another computing device. A computing device may be a client computer that communicates with a host computer in a multi-computer client-host system connected via a wired or wireless network including intranet and internet. The computing device can comprise an input device selected from a digital input device, such as a wired keyboard, a wireless keyboard, a digital writing pad, a touch screen, an input portal that can be connected to an electrical device or another computer, or any other digital devices that can input data into the computing device.

A computing device can also be configured to be coupled with a data input or output device via wired or wireless connections. A computing device can have a display device, such as a monitor screen. A computing device can also be a “portable computing device” such as a laptop computer, a pocket PC, a personal digital assistant (PDA), a handheld electronic processing device, a mobile phone, a smart phone that combines the functionality of a PDA and a mobile phone, a tablet computer, or any other stand alone or subunit devices that can process information and data and can be carried by a person.

A computing device can be connected to a wired or wireless network via wired or wireless connections. Wired connections include hardware couplings, splitters, connectors, cables or wires. Wireless connections and devices include, but not limited to, Wi-Fi device, Bluetooth device, wide area network (WAN) wireless device, Wi-Max device, local area network (LAN) device, 3G broadband device, infrared communication device, optical data transfer device, radio transmitter and optionally receiver, wireless phone, wireless phone adaptor card, or any other devices that can transmit signals in a wide range of electromagnetic wavelengths including radio frequency, microwave frequency, visible or invisible wavelengths.

The term “database” refers to a collection of related information that can be searched and retrieved. The database can be a searchable electronic numerical, alphanumerical or textual document; a searchable PDF document; a Microsoft Excel® spreadsheet; a Microsoft Access® database (both available from Microsoft Corporation of Redmond, Wash.); an Oracle® database (available from Oracle Corporation of Redwood Shores, Calif.); or a Linux database, each registered under their respective trademarks. The database can be a set of electronic documents, photographs, images, diagrams, or drawings, residing in a computer readable storage media that can be searched and retrieved. A database can be a single database or a set of related databases or a group of unrelated databases. “Related database” means that there is at least one common information element in the related databases that can be used to relate such databases. One example of the related databases can be Oracle® relational databases. A database can contain information such as user names, user identifications (IDs), passwords, list of security levels, and authorization levels. A database can also contain a plurality of documents.

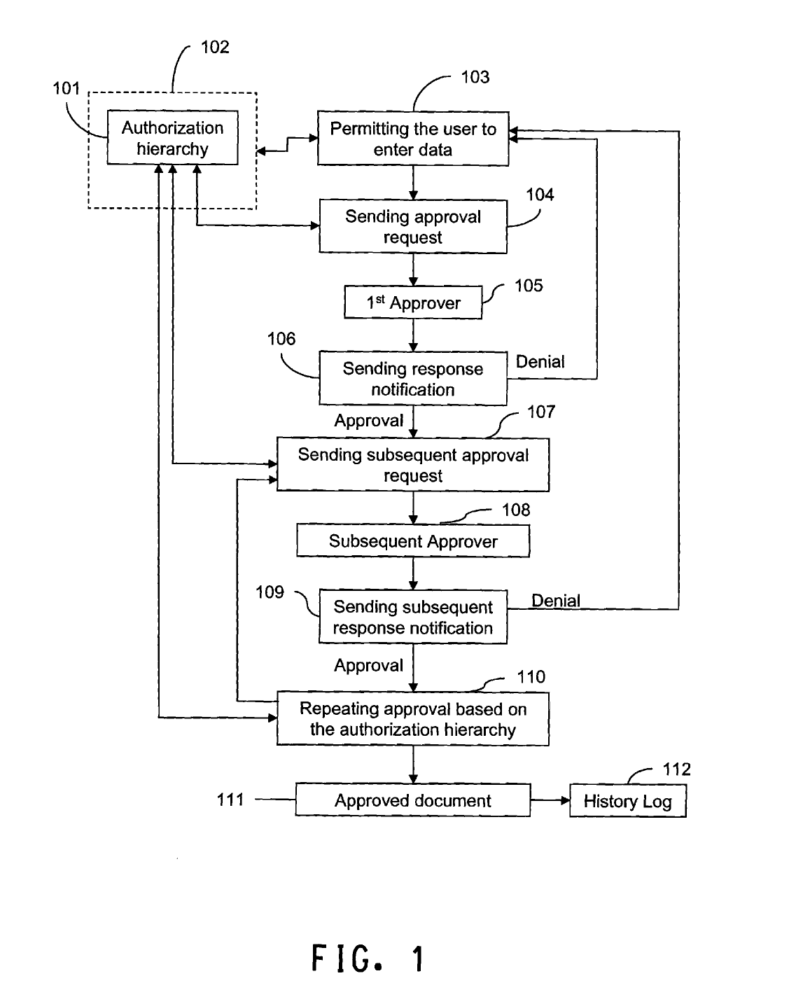

This invention is directed to a method for approval of a document. A representative flowchart of one embodiment of the method is shown in FIG. 1.

The document can be an existing document or a new document created by a user. The new document can be created de novo or according to an existing template. A new document created according to an existing template is preferred. In one example, an existing template comprises one or more fields that entry of any data or information into said fields requires one or more levels of approval according to an authorization hierarchy.

In one embodiment, the method comprises the following steps.

In step a), an authorized user is permitted to enter data into one or more fields of the document (103) to populate said fields, wherein each of said one or more fields is associated with an authorization hierarchy (101). The authorization hierarchy can be stored in a database (102).

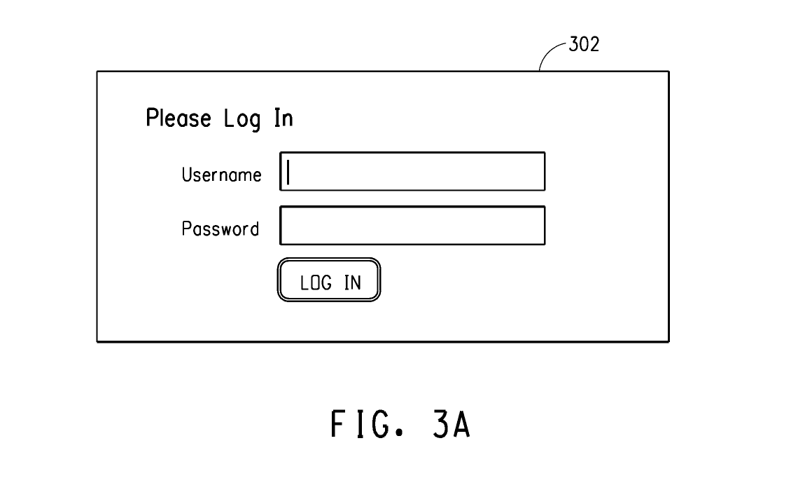

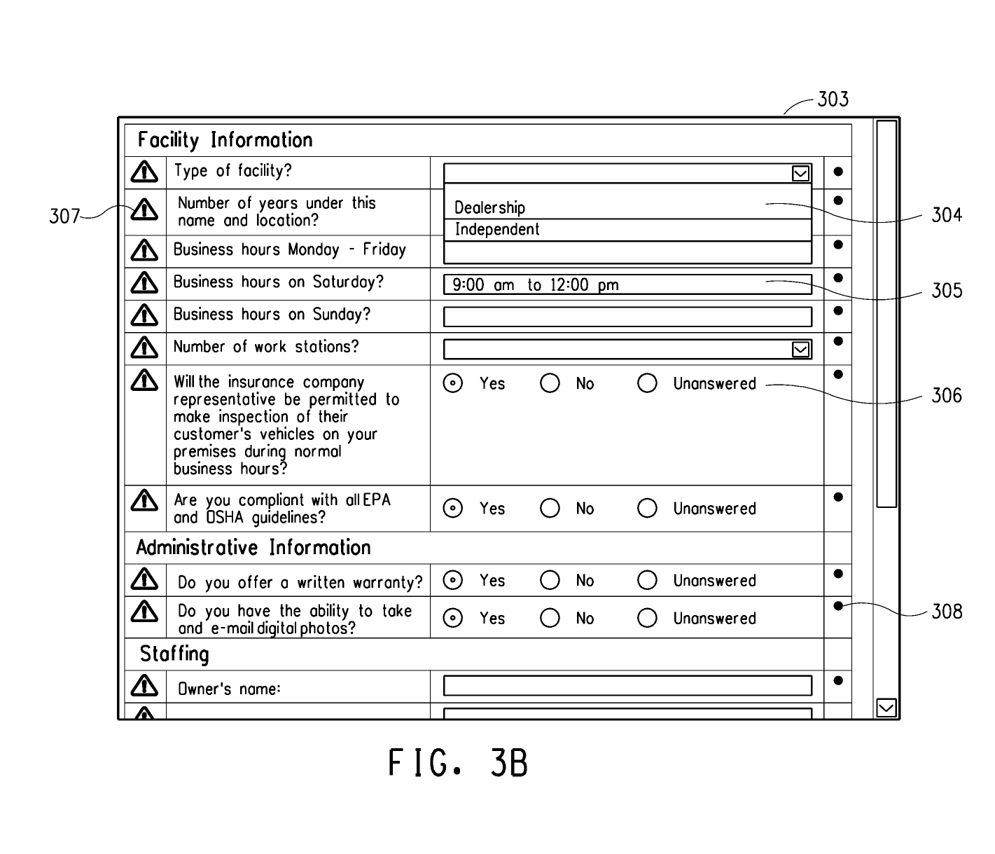

The authorized user, herein referred to as the user, is a person or persons and can be authorized through a number of authentication processes known to those skilled in the art. Examples of said authentication processes can include, but not limited to, requiring the user to provide a pair of user name (also known as user ID) and associated password; using an electronic identification (ID) card issued to the user and corresponding ID card reader; utilizing an electromagnetic transponder assigned to the user and associated receiver of the transponder; using an radio frequency identification (RFID) card assigned to the user and corresponding RFID card reader; using biometrics of the user, such as retina profile, facial recognition, finger prints, voice recognition, key stroke recognition and corresponding recognition devices known to those skilled in the art; or a combination thereof. A typical login interface (302) is shown in FIG. 3A. In such typical login interface, the user is required to provide a user name and a password. It is understood that configurations and arrangements of login interface or process are known to those skilled in the art and can be easily reconfigured or rearranged. Typically, user information, such as user names and corresponding passwords can be stored in a user database. The user database can be part of or related to database (102).

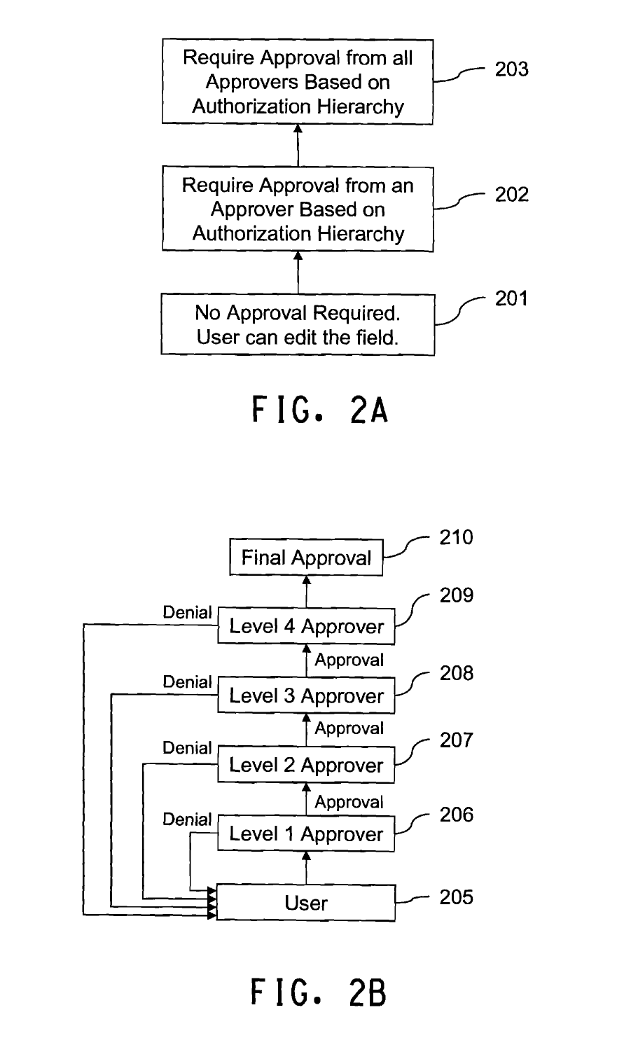

Each of the fields of the document can have data in forms of a single or a collection of characters, words, phrases, numbers, an entire file, or a combination thereof. Examples of the fields can have data such as a time period that defines the duration of a contract, a percentage that defines how profit is shared between parties of a contract, price, a clause that defines ownership of an article, or a paragraph describing how to safely mix a plurality of chemical compounds. The fields can also have an entire file such as a PDF file specifying terms and conditions of a contract. The one or more fields of the document can be associated with authorization hierarchy (101) through computer implemented methods known to those skilled in the art, wherein said authorization hierarchy comprises one or more levels of approvers. Optionally, each of the fields can be assigned a security level selected from a list of available security levels. An example of said list of security levels is shown in FIG. 2A. The list of security levels can be stored in a database, or part of a database, such as database (102). For example, one field can be assigned a first security level as “no approval required” and the user can enter any data or make any changes to that field (201, FIG. 2A) with any need for approval from any approvers. A second field can be assigned a second security level that requires approval from at least one approver (202). A third field may be assigned a third security level that requires approvals from multiple approvers (203). In another example, a plurality of fields can be assigned the security level that requires approvals from multiple approvers. The one or multiple approvers can be arranged to form aforementioned authorization hierarchy (101). The authorization hierarchy can be stored electronically and can be part of database (102). The security levels can be associated to the authorization hierarchy through computer implemented methods known to those skilled in the art. If a filed of the document is assigned a security level requires approval from one or more approvers, said field can be associated with the authorization hierarchy through computer implemented methods known to those skilled in the art.

A representative example of said authorization hierarchy is shown in FIG. 2B. In this example, the user (205) can enter data to one or more fields that require approval. An approval request for said one or more fields having data entered by the user can be submitted to a Level 1 Approver (206). Upon approval by the Level 1 Approver, a subsequent approval request can be generated and sent to a subsequent approver such as Level 2 Approver (207), then to a Level 3 Approver (208), and then to a Level 4 Approver (209), until a predetermined approval level is reached and the fields having the data get final approval (210). If the Level 1 Approver denies the data or changes entered into at least one of said fields, the user can be notified and resubmit data or changes. Another approval request can be generated and sent to the Level 1 Approver. The process can be repeated until a predetermined approval level is reached. Levels of approvers can be easily configured to fit any organizations. For example, in typical automobile vehicle repair industry, the user can be a body shop representative authorized to access the document, the Level 1 Approver can be a local manager of an insurance company paying part or all of vehicle repair costs to the body shop, a Level 2 Approver can be a division manager of the insurance company, a Level 3 Approver can be a regional Director of the insurance company while a Level 4 Approver can be a vice president of the insurance company. Numbers of approvers and levels of approval can be determined and configured by those skilled in the art. In one example, only one level of approver is needed. In another example, 3 or more levels of approvers are needed.

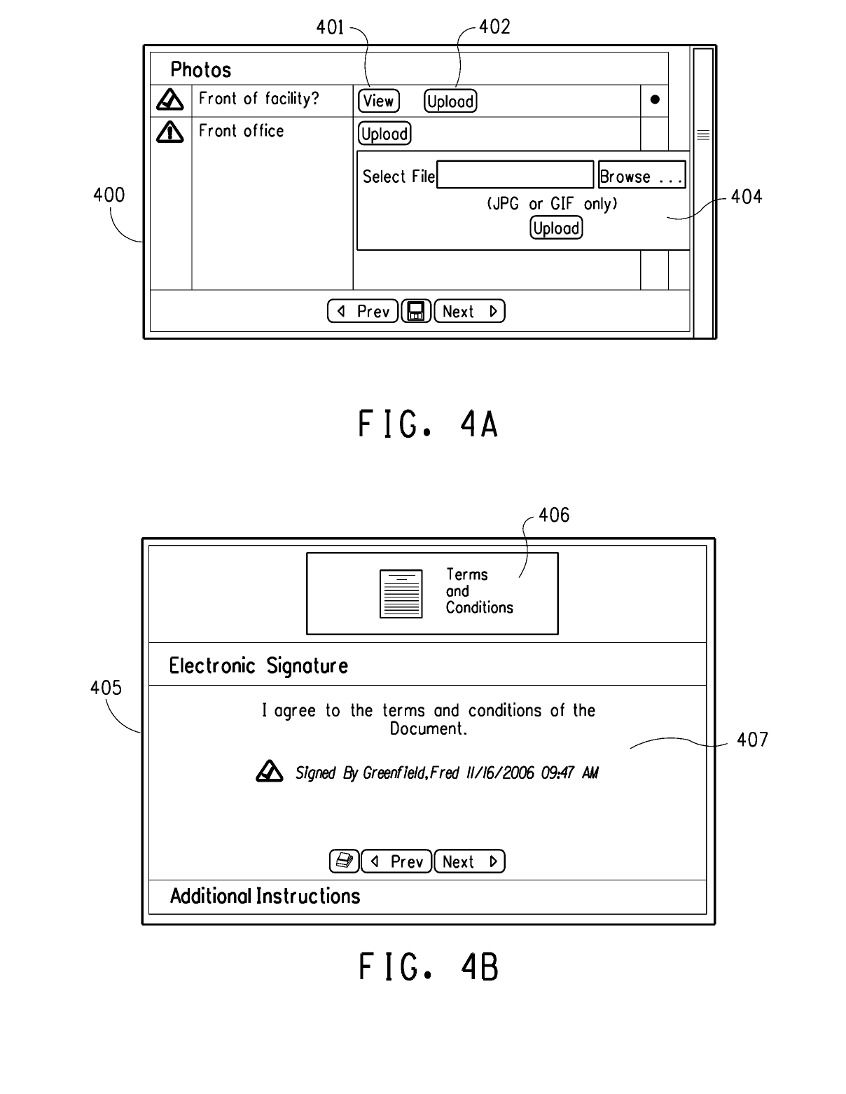

An example for creating a document based on an existing template is shown in FIG. 3B. In this template, the document is arranged into multiple fields with identifiers for each of said fields listed in areas (307). The user who logs in as an authorized user through login interface (302) can create the new document by entering data into the fields in a variety of ways, such as selecting from a pull-down menu (304), entering free text (305), or checking from preset selections (306). The user can also upload other electronic files into the document. Example of such electronic files can include, but not limited to digital photos, or other image files; a file in portable document format (PDF), such as Adobe® PDF file; a text file, such as Microsoft® Word file; and a text and image file, such as Microsoft PowerPoint file. FIG. 4A shows a representative example for uploading an image file. The user can use a typical interface (400) to view any existing files that have already been uploaded (401) or to upload a desired file using an upload button (402) and a subsequent pop-up interface (404). FIG. 4B shows a representative example for viewing an electronic file that is already part of the document, such as terms and condition of a contract. The user can use a typical interface (405) and click on a link (406) that leads to the terms and conditions. This typical interface (405) can be configured to show or add electronic signature of the user (407). Features and contents of any of the above mentioned interfaces can be added or reconfigured by those skilled in the art.

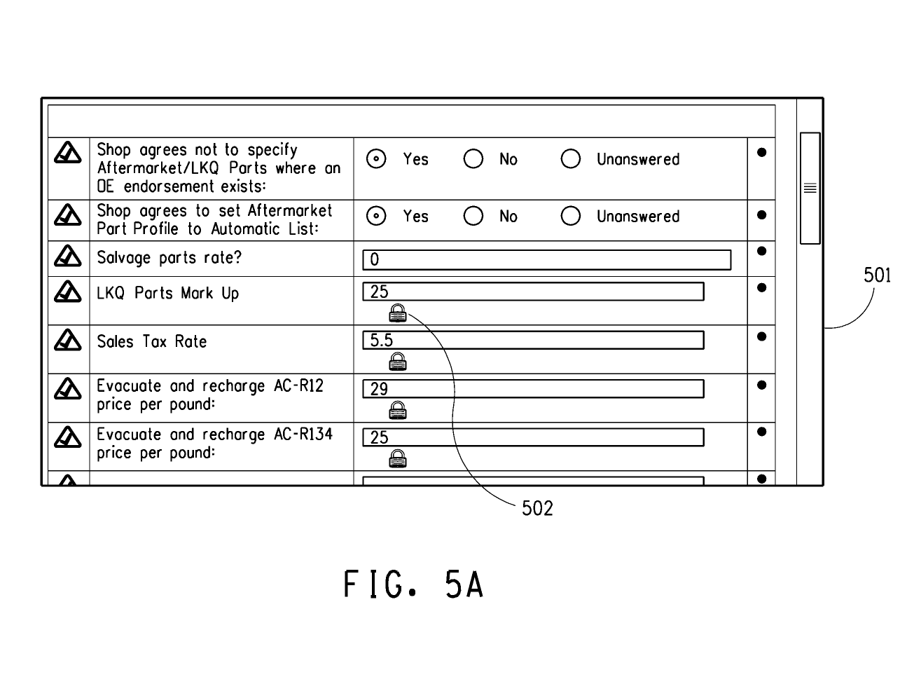

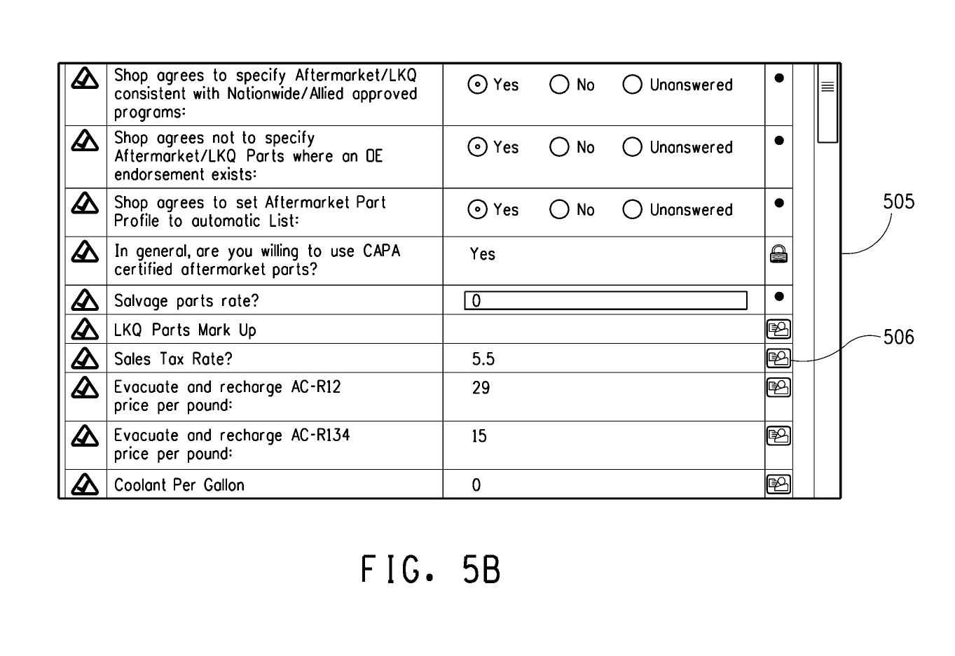

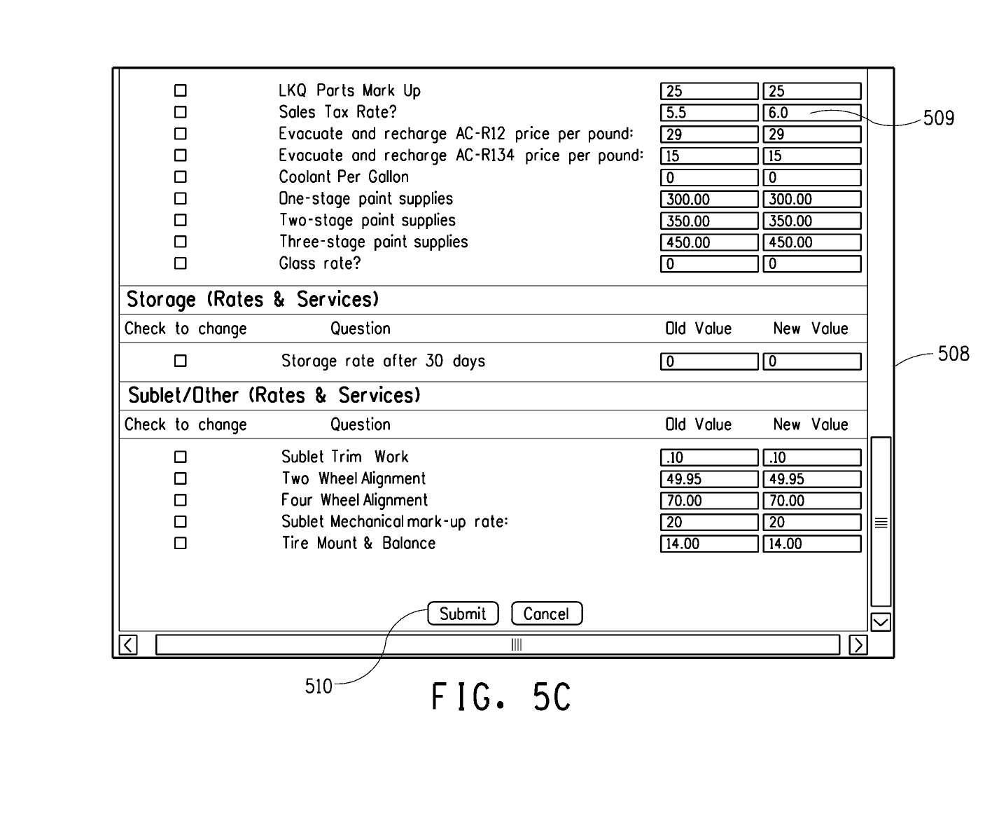

A representative example for entering new data or changes to populate one or more fields of an existing document is shown in FIG. 5. In an interface (501) (FIG. 5A), a field that has been assigned a security level requiring approval from at least one approver, herein referred to as a “locked field”, can be indicated by a symbol, such as a “padlock” symbol (502). Those skilled in the art can use other symbols or indications to indicate a locked field. The symbols or indications can include, but not limited to, graying out, highlighting, textural indication, or other image or text. When one or more of the locked fields need to be changes, the user can request unlocking the fields. In one example, the user needs to call a Level 1 Approver to unlock the locked field. In another example, the user sends an e-mail to a Level 1 Approver, or any other Approvers in an authorization hierarchy to unlock the locked field. In yet another example, each locked field can be provided with an unlock button. When said unlock button is clicked, an unlock notice is automatically sent to a predetermined person or persons who is authorized to unlock the field. The predetermine person or persons can be an approver of the authorization hierarchy. The predetermined person can also be a person outside of the authorization hierarchy who are not an approver, but has authorization to unlock the locked field. Typically, once a locked field is unlocked, a different symbol can be used to indicate its unlocked status, such as a symbol (506) in interface (505) in FIG. 5B. Other symbols, indications or texts can be used as determined appropriate by those skilled in the art. Upon unlocking, the user can enter data or changes, such as a new value into the field. One such example is shown in a field (509) in an interface (508) (FIG. 5C).

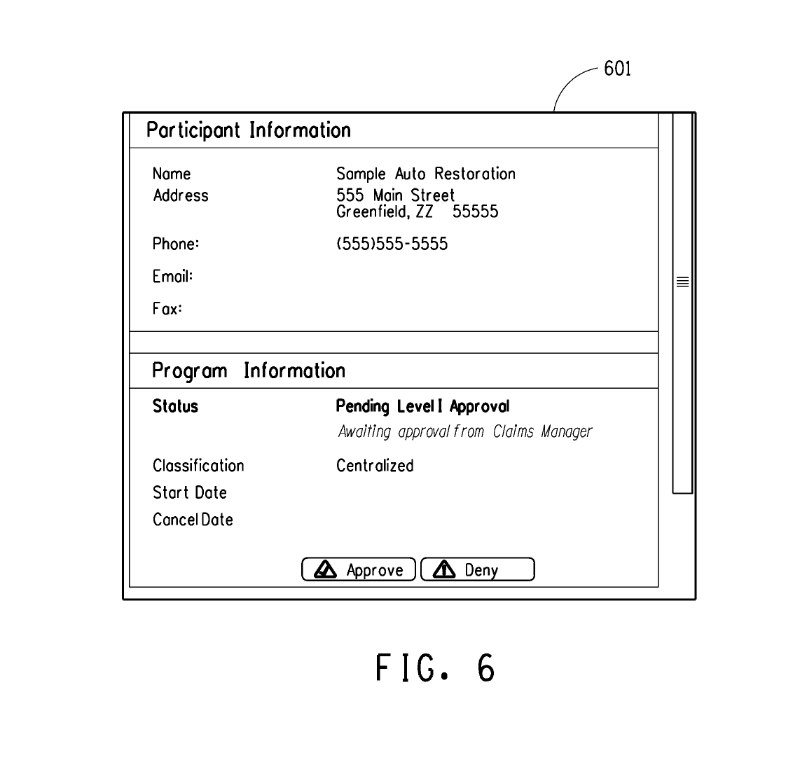

In step b), an approval request indicating the data entered or changed by the user in said fields can be generated and sent (104) to a initial approver (105) according to authorization hierarchy (101). In one example, the user can submit the data, generate and send the approval request by clicking on a submit button (510) in FIG. 5. After submitting the data, approval status can be displayed. One example of such approval status is shown in an interface (601) in FIG. 6. Typically, the approval request can be sent in the form of an e-mail. The approval request can also be sent in other forms including, for example, web messaging, pop up messaging, text messaging, instant messaging (IM), electronic paging, electronic fax, voice messaging, paper mail, traditional paper fax, or telegraphing. Typically, the approval request comprises a link that can lead to one or more fields of the document that require approval if an electronic approval request, such as an e-mail, is used. The approval request can further comprise information about the user such as names, address, phone number, or other identifications such as a user ID, codes, or any other information that can be used to identify the user. The approval request can further comprise status of the approval process. The link can be a hyperlink that can be clicked leading to an access point, such as a login interface. The approver is typically required to be authorized through an authentication process, such as providing his or her own user name and password to gain access to the document that requires approval. The approver's user name and password can be part of the user database and further can be part of database (102). The approver's authentication can be used to verify his or her authorization level in the authorization hierarchy.

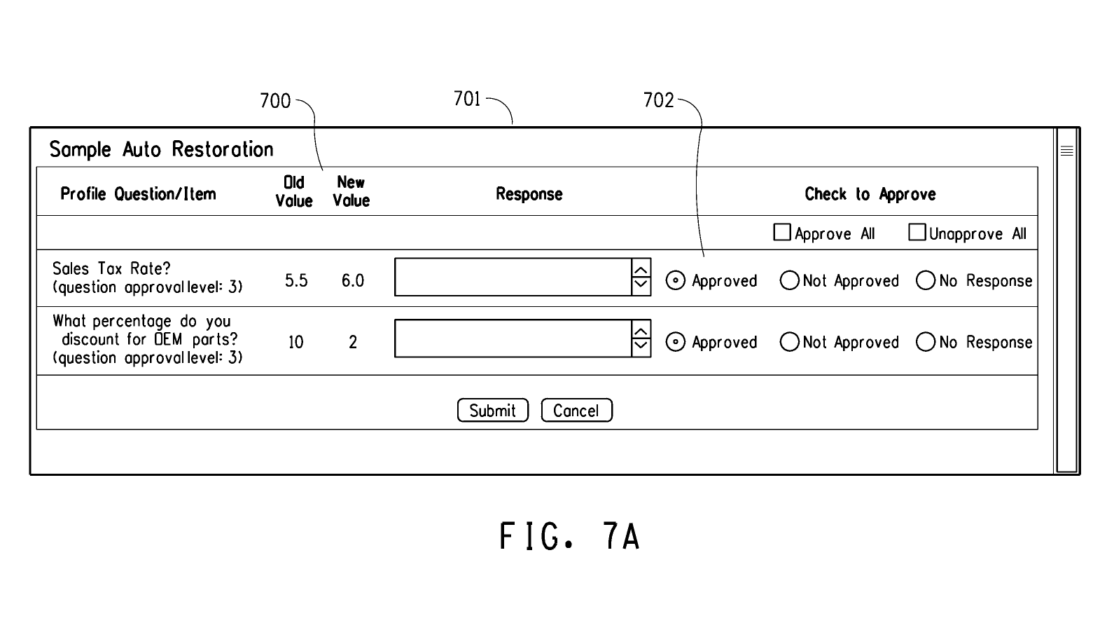

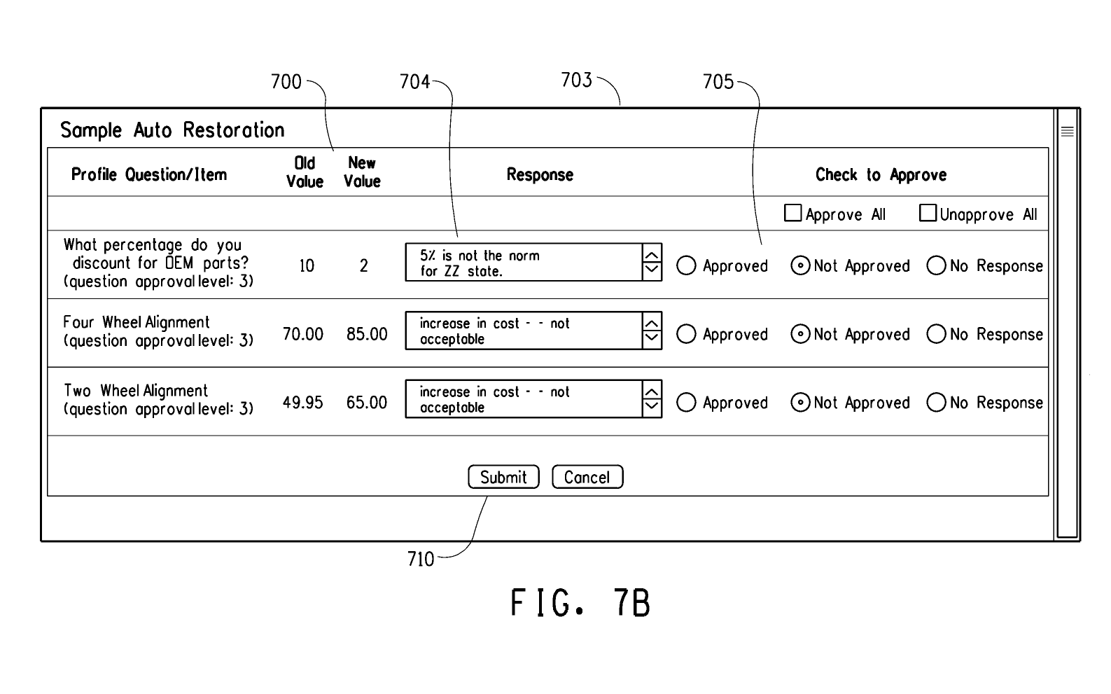

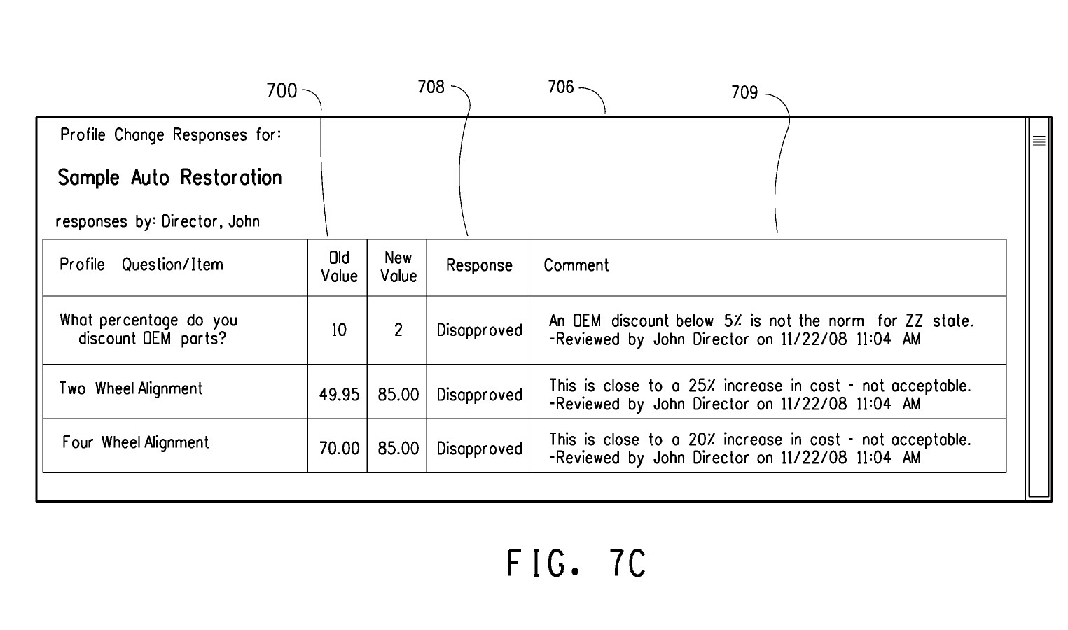

FIG. 7 shows typical screenshots for reviewing, approval or denial of the approval request by an approver. In one example, the approver clicks “Approved” radius (702) in interface (701) to approve the data or changes in one of said fields, such as a new value, entered by the user. In one configuration, if the document is an existing document, both old values and new values can be displayed in an area (700). If the document is a new document, there can be no old values. In another example, the approver clicks “Not Approved” radius (705) in interface (703). The approver can also enter comments in one or more designated response fields (704). The approver can approve all or deny all of said fields. The approver can also approve one or some of said fields while deny other of said fields. After making approval or denial selections and optionally entering comments, the approver can submit the response by clicking the “Submit” button (710).

In step c) and d), after the approver submits his or her response, a response notification can be generated based on input from the approver and sent to the user (106). The response notification is typically sent in the form of e-mail. The response notification can also be sent in other forms including, for example, web messaging, pop up messaging, text messaging, instant messaging (IM), electronic paging, electronic fax, voice messaging, paper mail, traditional paper fax, or telegraphing. Typically, a link is provided in the response notification that can lead to the document if an e-mail or other electronic notification form is used. The link can be a hyperlink that can be clicked leading to an access point, such as a login interface. The link can also directly lead to the document or the fields of the document if the user is already logged in and authorized.

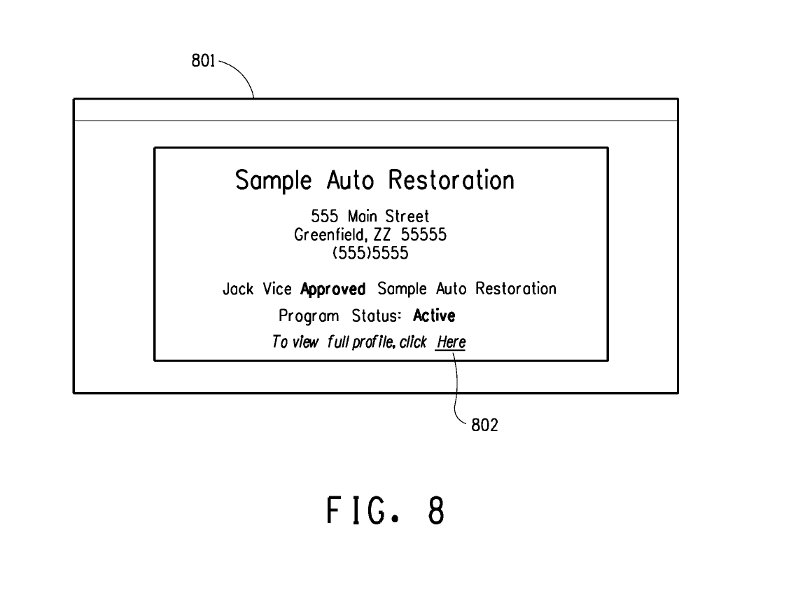

An example of a typical response notification is shown in FIG. 7C. In said example response notification, at least one of the fields that require approval is assigned an approval or denial. The approval or the denial can be indicated in a designated area, such as an area (708) in an interface (706). In one configuration, both an old value and a new value can be shown in an area (700), wherein the old value is a value in said field in existing document and the new value is a value that the user entered into said filed requiring approval. If said document is a new document being created from an existing template, there can be no old values. If the approver enters comments for one or more fields, that comments can be shown in an area (709). Another example of the response notification is shown in FIG. 8. In this example, all fields in the approval request are approved by the approver. A message shown in an interface (801) indicates that the approval request has been approved by the approver. The response notification can further provide a link, such as a link (802), to an approved document (111).

In step e), if at least one of the fields in the approval request is denied by the initial approver, a denial to said at least one field is indicated in the response notification. The steps a) through d) can be repeated so the user can enter new data into at least one of the one or more fields that is assigned the denial by the approver to repeat the approval process until said field is approved by the approver. Optionally, the approval process can be terminated as described below.

The approval process can be configured in such a way that when none of the fields in the approval request is approved or denied by the approver after a pre-determined period of time, such as a week, 10 days, or a month, the approval request is automatically approved. The process can also be set up in such a way that when none of the fields in the approval request is approved or denied by the approver after a certain period of time, the approval request is automatically denied.

The approval process can be further configured in such a way that when none of the fields in the approval request is approved or denied by one approver after a pre-determined period of time, such as a week, 10 days, or a month, an action notice is automatically sent to said approver, the user, or both the approver and the user. Said action notice can even be sent to an approver of higher approval level according to the authorization hierarchy. For example, if the initial approver, herein referred to as a Level 1 Approver (FIG. 2B), does not approve or deny the approval request within a pre-determined time period, such as a week, 10 days, or a month, an action notice can be automatically sent to the user, the initial approver, a Level 2 Approver according to the authorization hierarchy (FIG. 2B), or a combination thereof. In another example, only the initial approver and the Level 2 Approver are sent the action notice. In yet another example, if a Level 3 Approver does not approve or deny an approval request, an action notice can be sent to a Level 4 Approver. Those skilled in the art can determine and configure a computer program product to automatically send such action notices.

The user or any of the approvers can also order a termination of the approval process at any time. Typically, the user or the approver gives a termination notice to the other party and terminate the approval process. The termination notice can be integrated into the approval process by those skilled in the art. For example, the termination notice can be generated by clicking on a termination button placed in the document, in the approval request, or both the document and the approval request.

If the authorization hierarchy specifies additional one or more subsequent approvers, then the method of this invention further comprises the following steps.

In step g), after the approval request is approved by the initial approver, a subsequent approval request is generated and sent (107) to a subsequent approver (108) according to the authorization hierarchy. In one example, the authorization hierarchy specifies 4 levels of approvers: Level 1 Approver through Level 4 Approver. In this example, a subsequent approver is the Level 2 Approver, next subsequent approver is the Level 3 Approver, and the last subsequent approver is the Level 4 Approver. In another example, the authorization hierarchy specifies 2 levels of approvers: a Level 1 Approver and a Level 2 Approver. In such example, the subsequent approver is the Level 2 Approver.

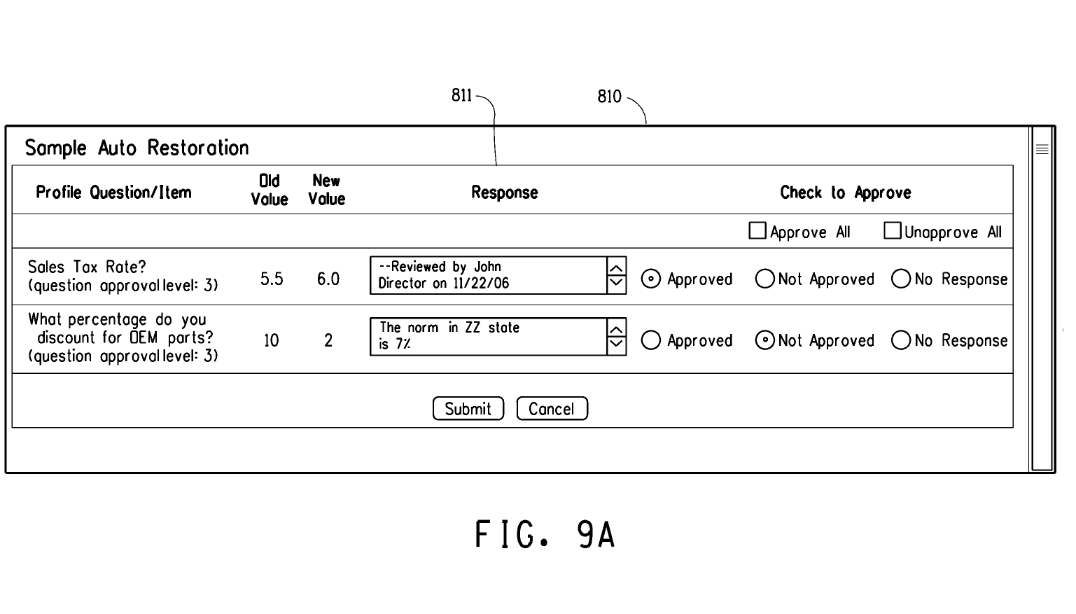

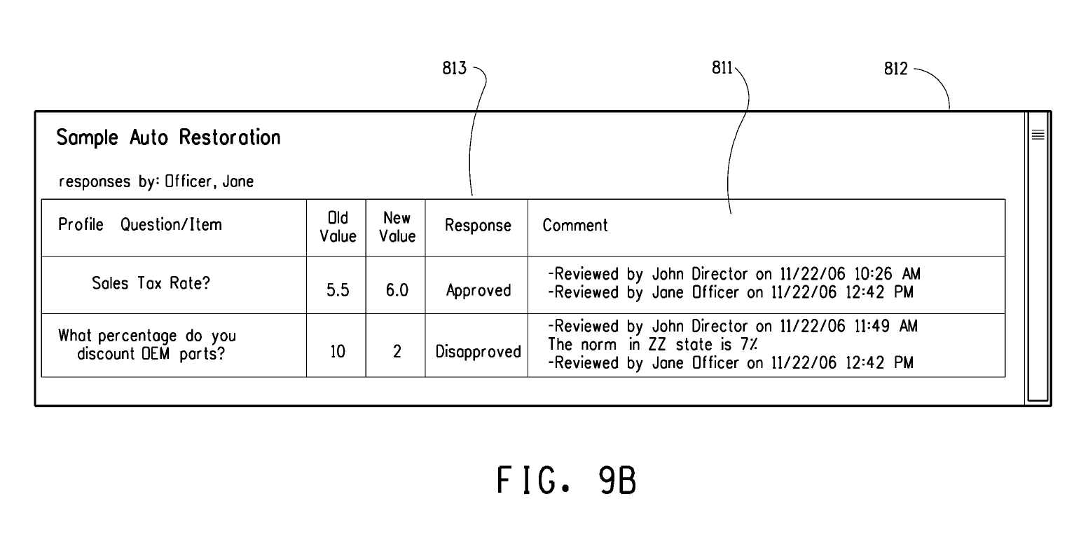

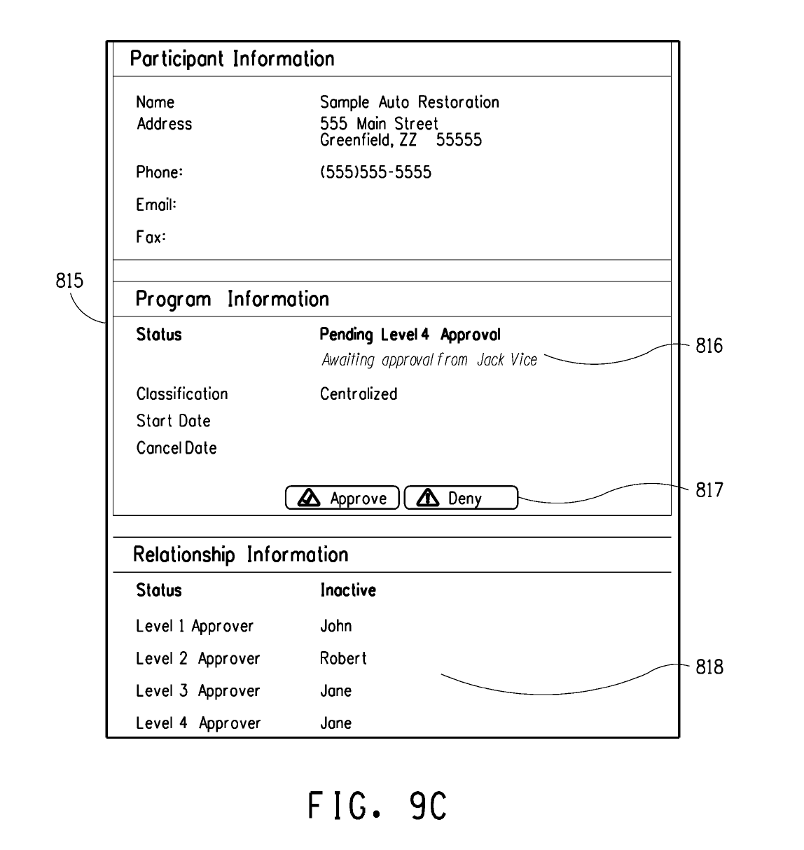

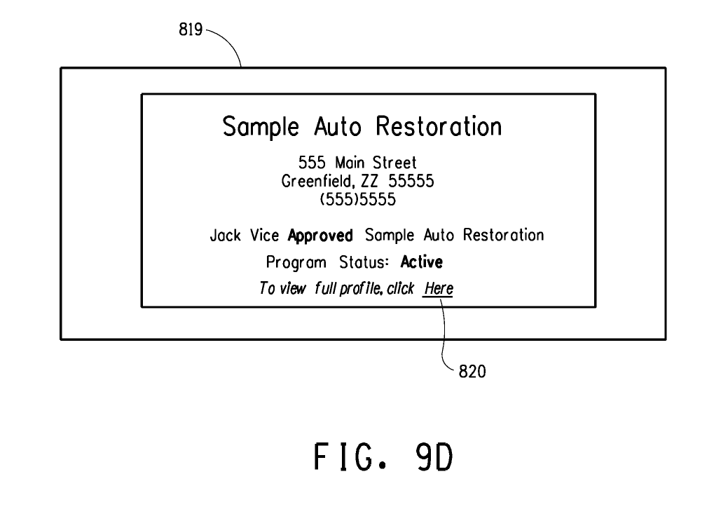

The subsequent approval request typically comprises responses from the first or any previous subsequent approver for the one or more fields populated with the data entered by the user. The subsequent approval request can also comprise a link to the document or the fields of the document. The subsequent approver can gain access to the document through aforementioned authentication process. One or more fields requiring subsequent approval can be shown in a representative interface (810) in FIG. 9A. Responses from previous approvers, such as the initial approver or a previous subsequent approver can be shown in a response area (811). Typically, names, and optionally titles, of the previous approvers can be shown. Time of responses of one or more previous approvers can also be recorded and shown. The subsequent approver can also enter comments into the response area, such as an area (811). The subsequent approver can submit his or her response and approve or deny the one or more fields all together or individually.

In step h) and k), after the subsequent approver submits his or her response, a subsequent response notification can be generated based on input from the subsequent approver and sent to the user (109). The subsequent response notification can be sent in the form of e-mail. Typically, a link can be provided in the subsequent response notification that can lead to the document. The link can be a hyperlink that can be clicked leading to an access point, such as a login interface, or directly to the document if the user is already logged in and authorized.

An example of a typical subsequent response notification is shown in FIG. 9B. Responses from the subsequent approver can be shown in a response area (813) in an interface (812). A record on the approver history, herein referred to as a history log (112), can be shown in an area (814).

History log (112) can comprise additional information include, but not limited to, information about a computer that one or more approvers use to access the document, such as a name of the computer, MAC address of the computer, software name and version; an IP address that the computer used to gain network access; date and time stamp; or physical location of the computer. The history log (112) can be stored on a client computer or a host computer. The history log can also be part of a database, such as database (102).

If the subsequent approver submits his denial for said one or more fields, the denial can be included in the subsequent response notification. The steps a) through k) can be repeated so the user can populate the one or more fields assigned subsequent denial with new data until the one or more fields with the new data are approved by the subsequent approver.

In step m), if the subsequent approver approves of the data in said fields of the document, another subsequent approval request can be sent to next subsequent approver according to the authorization hierarchy by repeating the steps g) through m) until a predetermined approval level is reached.

In one example, the last approver in the authorization hierarchy is a Level 4 Approver. The last approver can review the data in each of the fields and responses from all previous approvers. The last approver can approve or deny the approval request. A typical interface (815) is shown in FIG. 9C, wherein current approval status (816) and approval history (818) can be shown. The approval history (818) can be recorded as part of the history log. When the last approver submits his or her approval, such as by clicking on the approval button an area (817) of the interface (815), the approval process is completed. A final response notification, such as the response notification (819) in FIG. 9D, can be sent to the user along with a link (820) linking to the approved document (111).

The approved document can be stored in digital form. The history log can be included in the approved document. The approved document can be converted and printed into printed form. For example, after all fields are approved, the approved document including the data in the approved fields, and optionally the history log, is converted into a portable file format (PDF) document. The PDF document can be stored in digital form as a stand-alone digital file, part of another document, or in a database. The PDF document can also be printed on paper or other printable media, such as plastic or fabric.

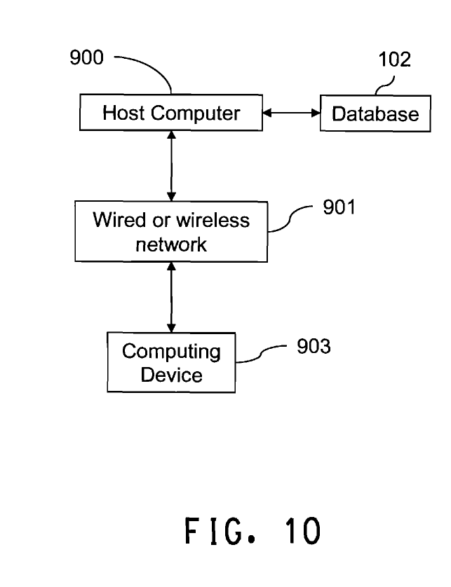

This invention is also directed to a system for approval of a document. One representative hardware configuration is shown in FIG. 10. In one embodiment, said system comprises:

a) a computing device (903) comprising an input device;

b) a database (102) accessible to the computing device, said database comprises information of an authorization hierarchy, and optionally a list of security levels;

c) a computer program product accessible to the computing device, said computer program product performs a computing process comprising the steps of:
i) populating one or more fields of the document with data entered into said input device by an authorized user, wherein each of said one or more fields is associated with an authorization hierarchy;
ii) sending an approval request for said one or more fields populated with the data to a initial approver in accordance with the authorization hierarchy;
iii) generating a response notification according to input from the initial approver, wherein in the response notification at least one of said one or more fields populated with said data is assigned an individual approval or an individual denial;
iv) sending the response notification to the user; and
v) repeating the steps i) through iv) to populate at least one of the one or more fields that is assigned the individual denial in the response notification with new data until said field is approved by the initial approver.

If the authorization hierarchy specifies additional one or more subsequent approvers, then the computing process of the system further comprises the steps of:
vi. sending a subsequent approval request for said one or more fields assigned the individual approval to a subsequent approver in accordance with the authorization hierarchy;
vii. generating a subsequent response notification according to input from the subsequent approver, wherein in the subsequent response notification at least one of said one or more fields in said subsequent approval request is assigned a subsequent approval or a subsequent denial;
viii. sending the subsequent response notification to the user;
ix. repeating the steps i) through viii) to populate at least one of the one or more fields that is assigned the subsequent individual denial with new data until said field is approved by the initial approver and the subsequent approver; and
x. repeating the steps vi) through ix) for said one or more fields assigned the subsequent approval to next subsequent approver until a predetermined approval level is reached.

The computing device of the system can be functionally connected to a wired or wireless network (901), such as an internet, intranet, or another one or more computers. The computing device can be a client computer or a terminal computer on the network and connected to one or more host computers. The computing device can be a desk top computer or a portable computer.

The document and the system including the computer program product can be functionally residing in the computing device or the host computer on the network and said computer program product is functionally accessible from the computing device through the network. Typically, the system can reside on a host computer on a network and the user can access the document and the system from a computing device connected to the network through an interface such as a web browser or any other interfaces.

The user or any of the approvers can log into the same computing device with corresponding user names and passwords. The user or the approvers can also log into different computing devices connected to the host computer through wired or wireless network. The user or the approvers can also log into the host computer.

What is claimed is:

1. A method for approval of a document, said method comprising the steps of:
a) populating one or more fields of the document with data entered by an authorized user, wherein each of said one or more fields is associated with an authorization hierarchy;
b) sending an approval request for said one or more fields populated with the data to a initial approver in accordance with the authorization hierarchy;
c) generating a response notification according to input from the initial approver, wherein in the response notification at least one of said one or more fields populated with said data is assigned an individual approval or an individual denial;
d) sending the response notification to the user; and
e) repeating the steps a) through d) to populate at least one of the one or more fields that is assigned the individual denial in the response notification with new data until said field is approved by the initial approver.

2. The method of claim 1 further comprising the steps of:
g) sending a subsequent approval request for said one or more fields assigned the individual approval to a subsequent approver in accordance with the authorization hierarchy;
h) generating a subsequent response notification according to input from the subsequent approver, wherein in the subsequent response notification at least one of said one or more fields in said subsequent approval request is assigned a subsequent approval or a subsequent denial;
k) sending the subsequent response notification to the user;
m) repeating the steps a) through k) to populate at least one of the one or more fields that is assigned the subsequent individual denial with new data until said field is approved by the initial approver and the subsequent approver; and
n) repeating the steps g) through m) for sending said one or more fields assigned the subsequent approval to next subsequent approver in accordance with the authorization hierarchy until a predetermined approval level is reached.

3. The method of claim 2 further comprising the step of automatically sending an action notice to the user, the first or the subsequent approver, an approver of higher approval level, or a combination thereof, if no response notification is sent from any of the approvers of said authorization hierarchy after a pre-determine period of time.

4. The method of claim 1, wherein the document is selected from: a contract, an agreement, a memorandum, a certificate, a resolution, an operation manual, an instructions, tutorial materials, material safety data sheets, a regulatory document, or a combination thereof.

5. The method of claim 1, 2, 3 or 4 further comprising the step of storing said individual approval, said individual denial, said subsequent individual approval, said individual denial, or a combination thereof, in a history log.

6. The method of claim 1, 2, 3 or 4 further comprising the step of terminating the approval of the document based on a termination order from the user or any of the approvers.

7. A system for approval of a document, said system comprising:
a) a computing device comprising an input device;
b) a database accessible to the computing device, said database comprises information of an authorization hierarchy;
c) a computer program product accessible to the computing device, said computer program product performs a computing process comprising the steps of:
i) populating one or more fields of the document with data entered into said input device by an authorized user, wherein each of said one or more fields is associated with an authorization hierarchy;
ii) sending an approval request for said one or more fields populated with the data to a initial approver in accordance with the authorization hierarchy;
iii) generating a response notification according to input from the initial approver, wherein in the response notification at least one of said one or more fields populated with said data is assigned an individual approval or an individual denial;
iv) sending the response notification to the user; and
v) repeating the steps i) through iv) to populate at least one of the one or more fields that is assigned the individual denial in the response notification with new data until said field is approved by the initial approver.

8. The system of claim 7, wherein the computing process further comprises the steps of:
vi) sending a subsequent approval request for said one or more fields assigned the individual approval to a subsequent approver in accordance with the authorization hierarchy;
vii) generating a subsequent response notification according to input from the subsequent approver, wherein in the subsequent response notification at least one of said one or more fields in said subsequent approval request is assigned a subsequent approval or a subsequent denial;
viii) sending the subsequent response notification to the user;
ix) repeating the steps i) through viii) to populate at least one of the one or more fields that is assigned the subsequent individual denial with new data until said field is approved by the initial approver and the subsequent approver; and
x) repeating the steps vi) through ix) for sending said one or more fields assigned the subsequent approval to next subsequent approver in accordance with the authorization hierarchy until a predetermined approval level is reached.

9. The system of claim 7, wherein the document is selected from: a contract, an agreement, a memorandum, a certificate, a resolution, an operation manual, or a combination thereof.

10. The system of claim 7, wherein the computing device is functionally connected to a network.

11. The system of claim 10, wherein the computer program product is functionally residing in a host computer on the network and said computer program product is functionally accessible from the computing device through the network.

12. The system of claim 11, wherein the document is stored on the host computer.

13. The system of claim 11, wherein the database is residing in the host computer.

14. The system of claim 10, wherein the network is a wired or a wireless network.

15. The system of claim 7, 8, 9, 10, 11, 12, 13 or 14, wherein the computing device is a portable computing device.

16. A method for approval of a document, said method comprising the steps of:
a) entering data by an authorized user to populate one or more fields of the document, wherein each of said one or more fields is associated with an authorization hierarchy;
b) submitting said data by said user to send an approval request for said one or more fields populated with the data to a initial approver in accordance with the authorization hierarchy;
c) receiving by said user a response notification generated according to input from the initial approver, wherein in the response notification at least one of said one or more fields populated with said data is assigned an individual approval or an individual denial;
d) repeating the steps a) through c) to enter new data by said user into at least one of the one or more fields that is assigned the individual denial in the response notification until said field is approved by the initial approver.

17. The method of claim 16 further comprising the steps of:
e) receiving by said user a subsequent response notification from a subsequent approver in accordance with the authorization hierarchy, wherein in said subsequent response notification at least one of said one or more fields is assigned a subsequent denial;
f) repeating the steps a) through e) to enter new data by said user into at least one of the one or more fields that is assigned the subsequent denial until said field is approved by the subsequent approver.

18. The method of claim 16 or 17, wherein the document is selected from: a contract, an agreement, a memorandum, a certificate, a resolution, an operation manual, an instructions, tutorial materials, material safety data sheets, a regulatory document, or a combination thereof.

19. A method for approval of a document, said method comprising the steps of:
a) receiving by an approver of an authorization hierarchy an approval request for approval of one or more fields of the document populated with data entered by an authorized user, wherein each of said one or more fields is associated with the authorization hierarchy;
b) inputting response by the approver to send a response notification to said user to approve or deny said one or more fields;
c) repeating the steps a) through b) to receive new approval request for new data entered by said user into at least one of the one or more fields that is denied in the response notification until said field is approved by the approver.

20. The method of claim 19, wherein the document is selected from: a contract, an agreement, a memorandum, a certificate, a resolution, an operation manual, an instructions, tutorial materials, material safety data sheets, a regulatory document, or a combination thereof.
